(19) United States
(12) Patent Application Publication
(10) Pub. No.: US 2002/0057494 A1
(43) Pub. Date: May 16, 2002

(54) BACK SURFACE MIRROR WITH PROTECTIVE COATING

(76) Inventor: HEINRICH LANG, ERGERSHEIM (DE)

Correspondence Address: JEFFREY M. KARMILOVICH, DORITY & MANNING, POST OFFICE BOX 1449, GREENVILLE, SC, 296021449

(21) Appl. No.: 09/267,821

(22) Filed: Mar. 12, 1999

(30) Foreign Application Priority Data
Jun. 9, 1998 (DE) 198 25 818.6

(51) Int. Cl. G02B 1/00

(52) U.S. Cl. 359/507

(57) ABSTRACT

A mirror pane for a back-surface mirror includes a carrier plate including a front side defining a first main surface and a back side defining a second main surface, a reflective coating disposed upon the second main surface, and a transparent, scratch-resistant protective coating disposed upon and covering the first main surface. The protective coating includes a nano-composite material.

### DESCRIPTION

The invention is concerned with a mirror pane for a back surface mirror, particularly for motor vehicles and also with a rearview mirror with a pane of this type.

Mirror panes in rearview mirrors in motor vehicles become dirty during rain due to spray because of their exposed position. The dirt interferes with the line of sight. This interference with sight must repeatedly be removed by manual cleaning. This frequent wiping leads to an increasing accumulation of dirt and other corrosive substances in the side areas of the mirror pane. In the side area, the various coatings extend beyond the glass and hence this side area is particularly subject to corrosion. This is particulary so in the case of back surface mirrors with silver as the reflecting coating. Thus, there exists a need for mirror panes, wherein the accumulation of dirt in the side areas is reduced.

It is known, from the technology of aviation, of coating the cockpit windshield pane with a water repellant coating. This water repellant coating prevents the buildup of streaking and because of the high air speed of airplanes, the line of sight for the pilot remains clear. Also, in the field of sanitary engineering, coatings for Plexiglas walls and shower enclosures, etc. are offered, which are dirt repellent and ease the cleaning thereof.

Thus the purpose of the invention is, to make available a mirror pane for back surface mirrors, in particular for rearview mirrors for motor vehicles, in which an accumulation of dirt and corrosive substances is prevented in the side and edge areas. In addition to this, it the purpose of the present patent, to make available a rearview mirror with a mirror pane of the type herein described.

The achievement of these purposes is accomplished by the features of Claims 1 and 7 of the present patent.

By coating the mirror pane with a known dirt and water repelling protective coating, following the practice of sanitary and flight technologies, the point reached is, that the spray water droplets coalesce into large drops, although the front of the mirror pane is facing away from the direction of travel and thus not encountering the passing air stream. By this coalescing into large drops, the dirt and other corrosive substances remain in suspension or solution in the rain water to be entrained in the passing wind and removed from the peripheral areas. A collective agglomeration of the corrosive substances in the said peripheral areas is thereby prevented.

Moreover, it has been counter intuitively determined, that these known protective coatings are very resistant to scratching and are also easier to free from frost and ice accumulations.

Set forth as especially well adapted for such protective coatings, the firm INM (Institute for New Materials, gem. GmbH) has developed and marketed an inorganic, nano-composite, gradiated coating with fluoridized organic side chains, which are presented as “Easy-to-clean-coatings”. Coatings using this material are optically transparent, exhibit a high UV stability as well as a high scratch and abrasion resistance.

This material is amenable to application by conventional means, such as dip, spray, or spin coatings, with subsequent photochemical and/or thermal hardening.

In accord with a particularly advantageous embodiment of the invention the protective coating is also extended over the sides and edges of the mirror pane, whereby the line of the interstitial boundary between the carrier plate and the reflection coating is sealed and protected. This is of the utmost importance where back surface mirrors using silver as the reflectant coating are concerned, since this mirror corrodes very easily, if the said boundary on the side edge is not protected. Normally, in the case of known back surface mirrors with silver as the reflectant coating, these sensitive boundaries are individually finished with a protective coating and sealed.

In the case of the mirror of the present invention, there simultaneously occurs the application of a dirt and water repellent coating on the front side, and a sealing of the said boundary on the side edges in one operation. The application of an additional protective layer, under these conditions, becomes superfluous.

Further details, features and advantages of the invention become evident in the following description of preferred embodiments with the assistance of the drawing.

There is shown in:

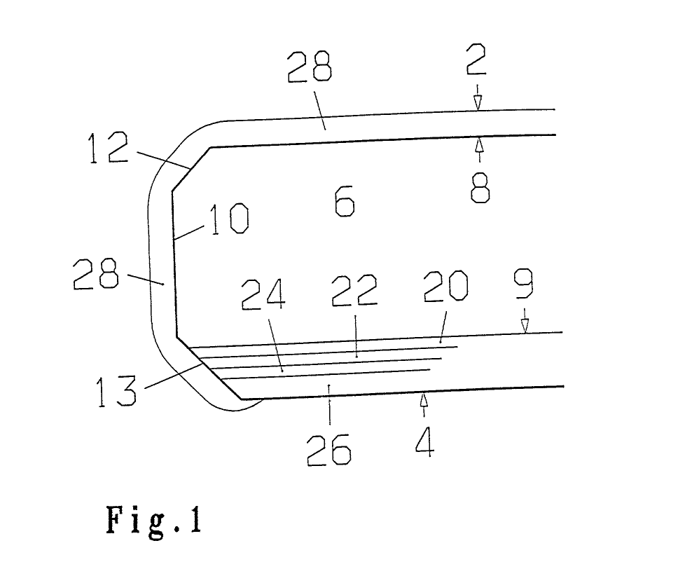

FIG. 1 a sectional presentation of a mirror pane of a back surface mirror with silver as the reflectant coating.

FIG. 1 shows an example embodiment of the invention in the form of a mirror plate with silver as the reflection coating. The mirror pane encompasses a glass plate 6 with a front main surface 8 and a back main surface 9. The edges of the side 10 are found in a upper area 12 and a lower area 13, both edges being beveled. On the back main surface 9, is found the following coatings, respectively: silver coating 20, on this a copper coating 22, next a coating of base lacquer 24, and finally a cover lacquer coating of 26. The glass plate 6 in the area of the second main surface 9 and the layers 20 to 26 form the lower beveled edge 13. On the upper main surface 8 of the glass plate 6, a protective coating is applied which also encapsulates side 10 with the upper and lower edges 12 and 13. Thus, with one working procedure, and with one protective coating, the protective coating 28 provides the front side 2 of the mirror pane, that is, the main surface 8 of the glass plate 6, and the corrosion sensitive sides 10, particularly the lower beveled edge 13, with a dirt and water repellent coating.

Claimed is:

1. A mirror pane for a back surface mirror, in particular for rearview mirrors in motor vehicles with a front side (2) and a back side (4), a transparent carrier plate (6), a reflective coating (20) on the back side (4) of the carrier plate (6), characterized by a transparent, scratch-free, dirt and water repellent protective coating (28) applied as the outermost coating on the front side (2) of the carrier plate (6).

2. A mirror pane in accord with claim 1, therein characterized, in that the protective coating (28) covers the interstitial border zone between the reflectant coating (20) and the carrier plate (6) as well as the side edges (10, 12, 13).

3. A mirror pane in accord with one of the foregoing claims, therein characterized, in that the protective coating (28) is comprised of an inorganic-organic nanocomposite gradient coating with fluoridized organic side chains.

4. A mirror pane in accord with one of the foregoing claims, therein characterized, in that the carrier plate (6) is comprised of glass.

5. A mirror pane in accord with one of the foregoing claims, therein characterized in that the carrier plate (6) is comprised of plastic.

6. A mirror pane in accord with one of the foregoing claims, therein characterized in that the reflection coating (20) is comprised of silver.

7. A rearview mirror for motor vehicles, in particular for commercial vehicles, with a swingable housing and an advantageously, pivotably secured mirror pane mirror, characterized therein by a mirror pane according to one of the foregoing claims.
